(19) United States
(12) Patent Application Publication
(10) Pub. No.: US 2006/0143973 A1
(43) Pub. Date: Jul. 6, 2006

(54) Bait saving hook with resilient bait guard

(76) Inventor: Newsome E. Corbitt III, Jacksonville, FL (US)

Correspondence Address: Mark J. Young, Suite 227, 9951 Atlantic Blvd., Jacksonville, FL, 32225, US

(21) Appl. No.: 11/027,251

(22) Filed: Dec. 30, 2004

(51) Int. Cl. A01K 83/06

(52) U.S. Cl. 43/44.8; 43/43.2

(57) ABSTRACT

A fish hook includes a resilient bait guard. The bait guard is comprised of an elastic (e.g., injection molded plastic) or pseudo-elastic (e.g., nickel titanium alloy) material that returns to a determined shape after deflection during normal use. The bait guard is shaped as a basket or cradle that is secured to the shank of a fish hook and releasably engaged on the barbed hook portion at its other end. A slider helps to hold the bait firmly in place on the hook. The bait guard may be transparent, water color, bait color or phosphorescent.

### FIELD OF THE INVENTION

This invention generally relates to fishing, and more particularly, to a fish hook including a resilient bait guard that is not readily perceptible to fish.

### BACKGROUND

Fish hooks known in the art have not successfully solved the problems of keeping bait from falling off a hook after repeated use. Prior art patents have used strand-type basket devices for a variety of purposes. Livermore, U.S. Pat. No. 51,951, shows a loop guard attached to the eyelet of a fish hook for engaging the hook point upwardly or downwardly in the mouth of the fish. Wentz, U.S. Pat. No. 2,608,791, and Kracht, U.S. Pat. No. 2,938,296, also show a guarded hook for engaging firmly in the mouth of the fish. Showalter, U.S. Pat. No. 3,465,466, shows a weed deflecting guard which closes the gap between eyelet and hook. Flowers, U.S. Pat. No. 4,229,001, shows a fish hook with an encircling holder into which live bait is inserted.

In U.S. Pat. No. 4,713,908 and U.S. Patent No. 5,009,026, fish hooks with bait guards are described which have been found to be effective for holding bait on a fish hook. Unfortunately, however, over time the malleable guard becomes distorted from bending. Bending may occur when removing bait, hooking a fish, and baiting and storing the hook. Such distortion interferes with use of the hook. The guard must be reshaped to properly engage the barbed point. Reshaping is tedious and may result in injury to fingers, as an angler meticulously re-bends the guard to conform to the hook. Failure to shape the guard so that it properly conforms to the hook may result in lost bait and/or prevent hooking a fish.

Another problem with such bait guards is that they may readily be detected by fish. The guard tends to be an unnatural structure that is highly visible to fish. Additionally, the resistance caused by the bait guard may be detected by a fish and interfere with or delay setting the hook.

The invention is directed to overcoming one or more of the problems as set forth above.

### SUMMARY OF THE INVENTION

To solve one or more of the problems set forth above, in an exemplary implementation of the invention, a fish hook with a resilient bait guard is provided. The bait guard is comprised of an elastic (e.g., injection molded plastic) or pseudo-elastic (e.g., nickel titanium alloy) material that returns to a determined shape after deflection during normal use. The bait guard is shaped as a wire basket or cradle that is secured to the shank, near the eye portion, of a fish hook at one end and engaged on the barbed hook portion at its other end. A slider around strands of the basket and the fish hook is configured to slide from adjacent the eye portion toward the hook portion to hold the bait firmly in place on the hook.

In another implementation, the bait guard is provided with color properties to reduce visibility or attract a fish. The bait guard may be transparent, water color, bait color or phosphorescent.

In yet another implementation, the bait guard may be comprised of a pseudo-elastic alloy adapted to return to a determined shape when external forces are removed from the bait guard.

It is an object of an exemplary embodiment of the invention to provide a fish hook having an improved resilient bait guard which returns to a determined configuration after deflection during normal use.

It is another object of an exemplary embodiment of the invention to provide a fish hook having a bait guard that is not readily detectible by fish.

It is yet another object of an exemplary embodiment of the invention to provide a fish hook having a bait guard that does not interfere with baiting or setting a hook.

### BRIEF DESCRIPTION OF THE DRAWINGS

The foregoing and other objects, aspects and advantages will be better understood from the following detailed description of an embodiment of the invention with reference to the drawings, in which:

FIG. 1 is a perspective view of a fish hook having a basket and slider of the invention engaged on the barbed point.

FIG. 2 is a perspective view of a fish hook of FIG. 1 having the basket disengaged from the barbed point.

FIG. 3 is a perspective view of a fish hook of FIG. 1 showing bait secured with the slider.

FIG. 4 is a perspective view of a fish hook including a single strand basket disengaged from the hook and a slider of the invention.

FIG. 5 is a perspective view of a fish hook of FIG. 4 having another embodiment of basket disengaged from the barbed point.

FIG. 6 is a perspective view of a treble fish hook including baskets on each hook and a slider of the invention.

### DETAILED DESCRIPTION

A fish hook according to an exemplary embodiment of the invention includes a wire basket bait guard, which may be comprised of a one-strand or a plurality of strands. The fish hook may be a single hook or a treble hook, and may be used for any type of bait. One end of the basket is wrapped around the eye of the fish hook or secured to the eye portion by solder or other securing means. The other end of the basket is engaged on the tip of the barbed point using a v-shaped notch or a loop. A slider, which encircles the hook and strands of the basket, slides to adjacent the bait and keeps the bait from falling off the hook, making it harder for fish to steal the bait, as well as helping the fisherman to feel the bite of the fish. Advantageously, the basket is comprised of a resilient material that returns to a determined shape when deflection forces are released during normal use.

The bait-saving fish hook of the invention enables repetitive use of the hook without having to re-shape the basket. Thus, time is saved, bait is secured and injury to fingers is avoided, allowing more fish to be caught.

Referring now to FIGS. 1-6 in which like numerals represent like parts, fish hook 2 has a barbed point 4 connected to shank portion 6. At the other end of shank portion 6 is eye portion 8, shown as a closed eyelet. Basket 10, which is preferably of wire, comprises at least one strand 12 secured to eye portion 8 at one end, by a bead of solder 13 or by other appropriate means, spaced apart from one side of the shank portion 6 and approximately the same length as and parallel to shank portion 6, strand 12, forming a v-shaped notch 16 engaging barbed point 4. The strand 12 continues, spaced apart from the other side of shank portion 6, as strand 14 which extends from v-shaped notch 16 to the eyelet portion 8 in a similar manner to strand 12, approximately the same length as and parallel to shank portion 6. Slider 20 is a wire ring or a ring made of plastic filament, or other material known to one skilled in the art, which may be moved along shank portion 6 as shown by the arrow in FIG. 1.

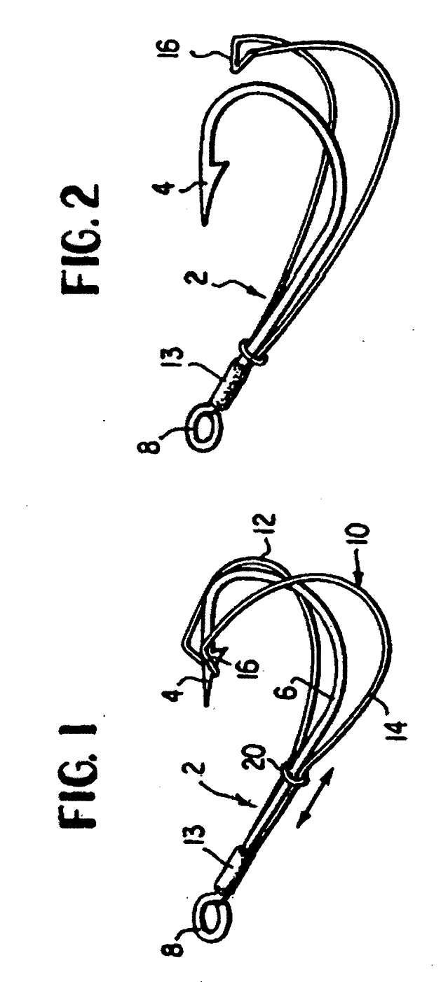

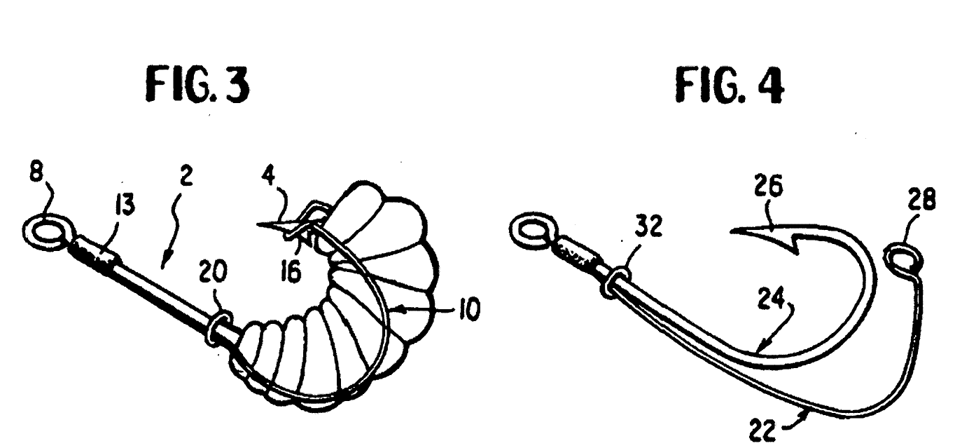

Slider 20 is located adjacent eye portion 8 while the bait guard is off the hook, as shown in FIG. 2, such as when bait is put on the hook. After bait has been put on the hook, notch 16 is engaged over barbed point 4 and slider 20 is pushed along the hook toward the barbed point, to hold the bait firmly in position, as shown in FIG. 3. Thus, bait is held securely between slider 20, bait guard 10 and barbed point 4.

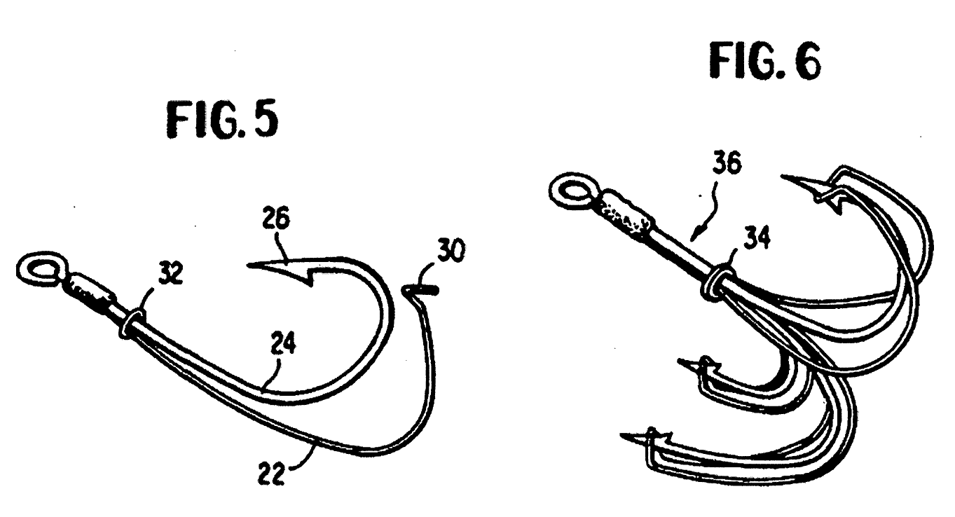

A single strand basket 22 is shown in FIG. 4, engaged on fish hook 24 similarly to the basket shown in FIGS. 1 to 3. The single strand basket is engaged on barbed point 26 by loop 28. FIG. 5 shows an embodiment similar to that of FIG. 4 in which loop 28 is replaced by notch 30 which may be engaged on barbed point 26, similarly to the engagement of notch 16 on barbed point 4, shown in FIGS. 1 to 3. Slider 32 of FIGS. 4 and 5 functions similarly to slider 20 of FIGS. 1 to 3.

FIG. 6 shows slider 34 engaged on treble hook 36 similarly to the slider engagement in FIGS. 1 to 5. The slider may be a wrapped loop of wire or other suitable flexible material, as illustrated by slider 34 of FIG. 6 or may be a soldered or adhesively secured loop, as illustrated by sliders 20 and 32 in FIGS. 1 to 5.

In use, the wire basket is removed form the barbed point, as shown in FIG. 2, the bait is fastened to barbed point 4, v-shaped notch 16 of basket 10 is engaged on barbed point 4, and slider 20 is pushed securely to firmly hold the bait adjacent to the barbed point, as shown in FIG. 3. The hook is cast into the water in the usual manner.

A slider of the invention may equally well be used whether the bait guard is a double strand bait guard, as illustrated in FIG. 1 to 3, or a single strand bait guard, as illustrated in FIGS. 4 and 5, or a treble bait guard, as illustrated in FIG. 6, or other similar variation. A treble hook may alternatively have a slider for each hook. The eye portion may be an open eye or a closed eye. The basket may be attached to the fish hook by wrapping, by winding the strands through the eye or around a portion of the hook adjacent the eye, adhesively, by solder or by other means known in the art. The basket may be wrapped on the eye portion of the fish hook by means of thread 18, such as thread of wire, plastic, linen or other appropriate material. Each strand may also be soldered, secured adhesively to the fish hook, or fastened by other equivalent means. Further, the bait guard of the invention may be used on a hook together with a skirt, weed guard, or other device commonly found in association with fish hooks.

By way of example and not limitation, the basket 10 may be formed of plastic. The hook 15 may be placed in an injection mold where thermoplastic resin may be injected and molded to form the basket 10. In such a construction, the bead of solder 13 is rendered unnecessary. The resin may be a polycarbonate, however other resins which may also be used, alone or in combination, include: Acrylonitrile Butadiene Styrene (ABS), Acrylic, Polymethyl Methacrylate (PMMA), Acrylic+Polycarbonate (Acrylic+PC), Tenite Acetate (CA), Tenite Butyrate (CAB), Tenite Propionate (CAP), Ethylene Tetrafluoroethylene (ETFE), Engineering Thermoplastic Polyurethane (ETPU), Ethylene Vinyl Alcohol Copolymer (EVOH), Methylmethacrylate Butadiene Styrene (MBS) Polyamide (Nylon), Polyamide 12 (Nylon 12), Polyamide 6 (Nylon 6), Polycarbonate+Polyethylene Terephthalate (PC+PET), Polycarbonate+Polyester, PCTA, PCTG, Polyarylate, Polyester Alloy, Polyester TP, Polyolefin, Polyphthlate Carbonate (PPC), Polystyrene (PS, GPPS), Polysulfone (PSU), Flexible Polyvinyl Chloride (Flexible PVC), Rigid Polyvinyl Chloride (Rigid PVC), Polyvinylidene Fluoride (PVDF), Styrene Acrylonitrile (SAN), Styrene Butadiene Block Copolymer (SB), Thermoplastic Elastomer (TPE), Thermoplastic Polyurethane Elastomer Polyether (TPU-Polyether), or other unspecified thermoplastics suitable for construction of a resilient, flexible basket 10.

Advantageously, the plastic forming the basket 10 may be transparent or colored so as to be substantially invisible in a body of water or otherwise colored to resemble the body of a bait fish or to at least catch the attention of a fish. This allows a fish to see the bait, but not be deterred by the basket 10. In the molding process, it is noted that polycarbonate typically has a yellowish tint. A blue colorant may be added such that the resulting molded plastic is generally clear. The plastic may further include additives such as phosphorescent compounds to provide other desired properties such as glow-in-the dark properties, or and thermal reactivity (e.g., color changes according to heat).

The resilient plastic basket 10 readily flexes during hook set, minimizing interference and delay with hook penetration. The hook 15 will thus set quickly and solidly and fewer fish will detect the basket and escape without being hooked. After external forces are removed, the basket will spring back to its original shape, ready for use again without having to reform the basket.

In an alternative embodiment, the basket 10 may be formed of a metal alloy that exhibits pseudo-elasticity. Pseudo-elasticity may be achieved by proper alloy formulation and heat treatment. Such materials used for a basket according to the principles of this invention include shape memory alloys which exhibit super-elastic/pseudo-elastic shape recovery characteristics. Such alloys are known in the art, but heretofore have not been tailored for or applied to bait guards. These alloys are characterized by their ability to be transformed from an austenitic crystal structure to a stress-induced martensitic (SIM) structure at certain temperatures, and return elastically to an austenitic structure when the stress is removed. These alternating crystalline structures provide the alloy with its super-elastic properties. One such well-known alloy, nitinol, is a nickel-titanium alloy. It is readily commercially available and undergoes the austenite-SIM-austenite transformation at a variety of temperature ranges between −20° C. and 30° C. These alloys are especially suitable because of their capacity to elastically recover almost completely to the initial configuration once a stress is removed. Typically there is little plastic deformation, even at relatively high strains. This allows the basket to undertake substantial bends as a hook is baited and a fish bites, and yet return to its original shape once the stress has been removed without retaining any hint of a kink or a bend. Additionally, compared to stainless steel, less force need be exerted to deform the basket thereby decreasing detection by a fish and resistance to setting the hook.

While the invention has been described in terms of various embodiments and implementations, those skilled in the art will recognize that the invention can be practiced with modification within the spirit and scope of the appended claims. The physical embodiments described above merely exemplify the invention, which may be embodied in other specific structure within spirit and scope of the claims appended hereto.

We claim the following:

1. A fish hook including a bait guard, said fish hook comprising a rearward eye portion, an intermediate shank portion, and a forward hook portion,
said bait guard comprising a resilient strand adapted for keeping bait on the hook, said strand including an elongated flexible member secured to the shank, extending forwardly along a side of the shank portion, following the curve of the hook portion and extending rearwardly to and in releasable engagement with a barbed point on the end of the hook portion.

2. A fish hook including a bait guard according to claim 1, said fish hook further including a slider encircling the elongate flexible member of the bait guard and the shank portion of the fish hook, and being movable along the hook between the eye portion and the hook portion.

3. A fish hook including a bait guard according to claim 1, wherein the bait guard is comprised of injection molded resilient plastic.

4. A fish hook including a bait guard according to claim 3, wherein the plastic is substantially transparent.

5. A fish hook including a bait guard according to claim 3, wherein the plastic is tinted substantially the color of a bait.

6. A fish hook including a bait guard according to claim 3, wherein the plastic is tinted substantially the color of water in which the fish hook will be used.

7. A fish hook including a bait guard according to claim 3, wherein the plastic includes a phosphorescent additive adapted to impart a glow-in-the dark property to the bait guard.

8. A fish hook including a bait guard according to claim 3, wherein the flexible member is a continuous strand releasably engaging the barbed point in a notch in the strand.

9. A fish hook including a bait guard according to claim 3, wherein the flexible member is a continuous strand releasably engaging the barbed point in a loop in the strand.

10. A fish hook including a bait guard according to claim 1, wherein the bait guard is comprised of a pseudo-elastic alloy.

11. A fish hook including a bait guard according to claim 10, wherein the pseudo-elastic alloy includes a titanium alloy.

12. A fish hook including a bait guard according to claim 10, wherein the pseudo-elastic alloy includes a nickel-titanium alloy.

13. A fish hook including a bait guard according to claim 10, wherein the flexible member is adhesively secured to the shank portion.

14. A fish hook including a bait guard according to claim 10, wherein the flexible member is soldered to the shank portion.

15. A fish hook including a bait guard according to claim 10, wherein the flexible member is secured to the shank portion by mechanical attachment.

16. A bait guard of claim I wherein said fish hook comprises a multiple hook portion including a bait guard on at least one hook.

17. A bait guard claim 16 wherein said fish hook comprises a bait guard on each hook.
